(19) United States
(12) Patent Application Publication
(10) Pub. No.: US 2007/0278973 A1
(43) Pub. Date: Dec. 6, 2007

(54) Drive circuit for an ignition element of a safety system

(75) Inventors: Olaf Just, Munich (DE); Josef Limmer, Unterfoehring (DE); Timo Dittfeld, Munich (DE)

Correspondence Address: Maginot, Moore & Beck;Chase Tower, Suite 3250, 111 Monument Circle, Indianapolis, IN, 46204, US

(73) Assignee: Infineon Technologies AG, Munich (DE)

(21) Appl. No.: 11/787,202

(22) Filed: Apr. 13, 2007

(30) Foreign Application Priority Data
Apr. 13, 2006 (DE) 102006017579.4-21

(51) Int. Cl. H05B 41/36

(52) U.S. Cl. 315/291

(57) ABSTRACT

A drive circuit for an ignition element of a safety system comprises at least one ignition element terminal for connection of the ignition element, and a controllable current or voltage source coupled to the at least one ignition element terminal. A sensor arrangement comprising at least one detector element is arranged in a current path or adjacent to a current path between the current or voltage source and the at least one ignition element terminal and which has a sensor material designed to vary its color indirectly or directly dependent on a current flowing between the current or voltage source and the ignition element.

### TECHNICAL FIELD

The present application relates to a drive circuit for an ignition element of a safety system, in particular of an occupant protection system of a motor vehicle, such as an airbag or seatbelt pretensioner, for example.

### BACKGROUND

If an accident event occurs which requires triggering of a passenger protection system, i.e. for example opening of the airbag or pretensioning of the seatbelts, such a drive circuit drives the ignition element in such a way that a triggering current is applied to it for a predetermined time duration. In this connection, said time duration and the amplitude of the current are chosen such that ignition of the ignition element and hence triggering of the protection system are achieved as reliably as possible.

The ignition element can only be used once and is destroyed when the protection system is triggered. In order, after an accident event, to make it possible to analyze the way the accident happened, it is necessary to obtain information about a current that flowed through the ignition element.

### SUMMARY

A drive circuit for an ignition element of a safety system according to one embodiment of the invention comprises at least one ignition element terminal for connection of the ignition element, a controllable current or voltage source coupled to the at least one ignition element terminal, and a sensor arrangement. The sensor arrangement has at least one detector element which is connected between the current or voltage source and the at least one ignition element terminal and has a sensor material varying color indirectly or directly dependent on a current flowing between the at least one ignition element terminal and the ignition element.

Embodiments of the invention are explained in more detail below with reference to figures.

### BRIEF DESCRIPTION OF THE DRAWINGS

FIG. 1 schematically shows a drive circuit according to an embodiment of the invention for an ignition element of a safety system, having a detector element connected between a current or voltage source and an ignition element terminal.

FIG. 2 schematically shows a detector element having a thermochromic sensor material applied to an electrically conductive carrier.

FIG. 3 illustrates a possible mounting of the sensor material on the carrier in the case of a detector element in accordance with FIG. 2.

FIG. 4 shows an electrically conductive carrier to which a plurality of thermochromic sensor materials having different transition temperatures are applied.

FIG. 5 shows a drive circuit having a detector element connected between a current or voltage source and an ignition element, and having a reference detector element.

FIG. 6 shows an electrical equivalent circuit diagram of a detector element having an electrochromic cell.

FIG. 7 schematically illustrates the construction of an electrochromic cell.

FIG. 8 shows a first example of a drive circuit having two detector elements.

FIG. 9 shows a second example of a drive circuit having two detector elements.

FIG. 10 shows an example of a drive circuit having a Hall element inductively coupled to a connection line and a detector element driven by the Hall element.

FIG. 11 shows an example of a controlled current source.

### DETAILED DESCRIPTION OF THE INVENTION

In the figures, unless specified otherwise, identical reference symbols designate identical parts with the same meaning.

A drive circuit for an ignition element of a safety system according to one embodiment includes at least one ignition element terminal for connection of the ignition element, a controllable current or voltage source coupled to the at least one ignition element terminal, and a sensor arrangement. The sensor arrangement has at least one detector element which is connected between the current or voltage source and the at least one ignition element terminal and has a sensor material varying color indirectly or directly dependent on a current flowing between the at least one ignition element terminal and the ignition element.

The sensor material may be an irreversible thermochromic material, which are generally known. Irreversible thermochromic materials have a transition temperature at which an irreversible change in the color of the material occurs if the material is heated to this temperature.

After triggering of the ignition element by a current flowing from the current or voltage source, the use of an irreversible thermochromic material as sensor material in the drive circuit indirectly yields information regarding said current. This indirect information consists in a heating of the surroundings of the sensor material caused by said current.

The thermochromic sensor material of the detector element is applied for example to an electrically conductive carrier that is connected between the at least one ignition element terminal and the controllable current or voltage source and is directly heated by the ignition current that flows. In this case, the heating of the carrier, and hence of the sensor material, is dependent on the electrical power converted into heat in the carrier. Said power is in turn dependent on the carrier's electrical resistance, which is known or can be determined in a simple manner, and the ignition current that flows.

Customary thermochromic materials have only one transition temperature at which a color transition from a first color to a second color takes place, so that no further color transition takes place in the event of a further increase in temperature beyond said transition temperature. In order to obtain more differentiated information about the temperature in the event of the triggering of the ignition element—and hence about the ignition current—the detector element may comprise a plurality of thermochromic sensor materials having different transition temperatures.

Instead of a thermochromic material applied to an electrically conductive carrier, an electrically conductive thermochromic polymer may be used, which is then connected directly into a connecting line of the ignition element between the current or voltage source and the ignition element.

Furthermore an electrochromic material as sensor material of the detector element may be used. Such electrochromic materials are generally known. Electrochromic materials have the property of changing their color depending on an electric field to which they are exposed.

The electrochromic sensor material is for example part of an electrochromic cell having two electrodes between which the electrochromic sensor material is arranged and which generate, under the influence of an electrical charge stored on the electrodes, an electrical field that influences the color of the sensor material. Said cell is for example connected in parallel with an electrical resistance connected between the current or voltage source and the ignition element, with the result that the electrodes are charged in the case of an ignition current that flows.

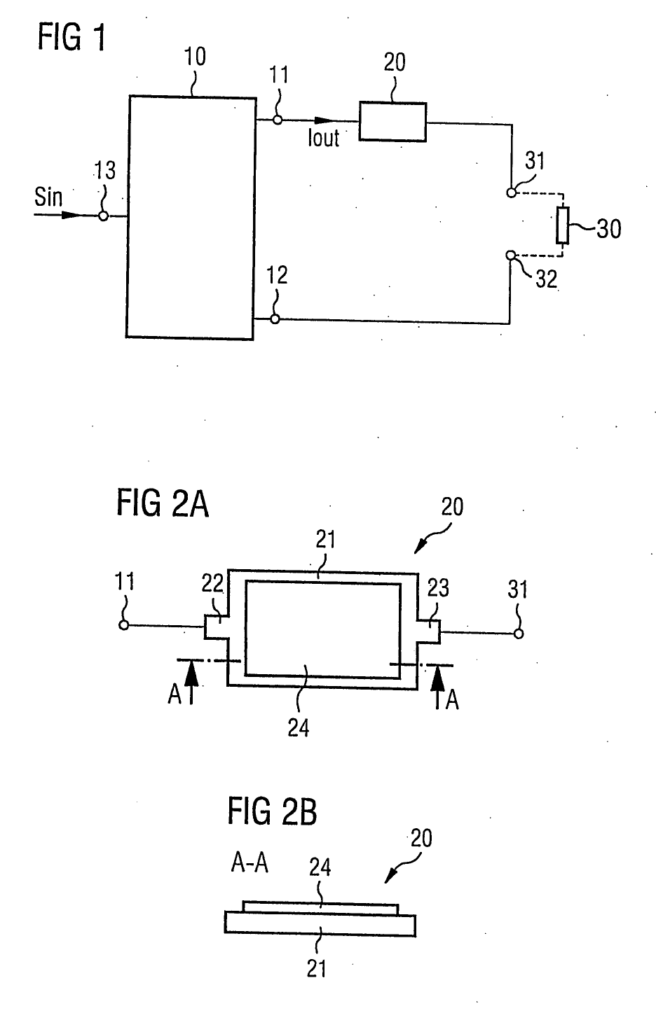

FIG. 1 schematically shows an example of a drive circuit for an ignition element 30 of a safety system, for example of an airbag system or of a seatbelt pretensioner system in a motor vehicle. Said drive circuit has two ignition element terminals 31, 32 for connection of the ignition element 30 (illustrated by dashed lines) and a controllable current or voltage source 10. Said controllable current or voltage source is coupled to the ignition element terminals 31, 32 by terminals 11, 12 and is designed to generate an ignition current Iout for the ignition element 30 according to a control signal Sin, which can be fed in via a control input 13.

The controllable source 10 comprises, referring to FIG. 11, for example, a current source 13 connected in series between the first output terminal 11 and a terminal for a first supply potential V1, and optionally a second switch 15 connected between the second output terminal 12 and a second supply or reference potential GND. In this case, the two switches are driven by the control signal Sin. In the case of this controllable source 10, an ignition current Iout flows only when both switches 14, 15 are driven in conducting fashion.

A customary ignition element of an airbag system ignites if a current of between 1 A and 2 A is applied to it for a time duration of between 0.5 ms and 3 ms.

In order, after the ignition element 30 has been driven by an ignition current provided by the controlled current or voltage source 10, subsequently to obtain information about the amplitude and/or duration of the ignition current Iout that flowed, a detector element 20 is provided in the drive circuit. In the example in accordance with FIG. 1, said detector element is connected between the first connecting terminal 11 of the current or voltage source 10 and the first ignition element terminal 31 in the driving current path of the ignition element 30.

The detector element 20 has a sensor material designed to vary its color indirectly or directly dependent on a current Iout flowing between the current or voltage source 10 and the ignition element 30.

Referring to FIGS. 2A and 2B, said detector element 20 comprises for example an electrically conductive carrier 21 with terminal contacts 22, 23 arranged at a distance from one another and an irreversible thermochromic sensor material 24 applied to the carrier 21. The sensor material, designated by the reference symbol 24 in FIGS. 2A and 2B, may contain, in addition to a thermochromic material that changes its color depending on the temperature, a suitable adhesive or binder that adheres on the electrically conductive carrier 21.

Alongside many others, suitable thermochromic materials are for example ammonium vanadate (NH₄VO₃), which changes its color from white to brown at a transition temperature of between 140° C. and 150° C., or cobalt ammonium phosphate (CoNH₄PO₄.H₂O), which changes its color from violet to blue at a transition temperature of between 165° C. and 175° C. Suitable adhesives or binders are for example polymeric binders, such as acrylic resins.

After triggering of the drive circuit, that is to say after generation of an ignition current Iout for the ignition element 30, the irreversible thermochromic sensor material 24 indirectly yields information about the current that flowed to the ignition element Iout or the time duration during which said current flowed. The detector element 20 enables a statement to be made about whether the temperature of the detector element 20, due to the ignition current Iout flowing through the detector element 20, exceeded a predefined threshold value, which is determined by the transition temperature of the thermochromic material used. In this case, the thermochromic sensor material 24 should be chosen such that its transition temperature is very high in comparison with customary operating temperatures to which the drive circuit is exposed during customary operation. In this case, when the transition temperature of the sensor material is exceeded, which can be identified through a change in color of the sensor material, it can be assumed that this exceeding of the transition temperature is critically caused by the electrical power converted into heat in the detector element 20. In this case, the electrical power converted into heat in the detector element is given by:
P_{w}=Iout²·R₂₁ (1).

In this case, P_{w} denotes the electrical power converted into heat, Iout denotes the ignition current and R₂₁ denotes the electrical resistance of the carrier element 21. With knowledge of the thermal capacity of the electrically conductive carrier element 21 and with knowledge of the transition temperature, after a change in color of the sensor material 24 it is possible to make a statement about the electrical power converted into heat in the carrier 21 and hence about the ignition current Iout that flowed previously.

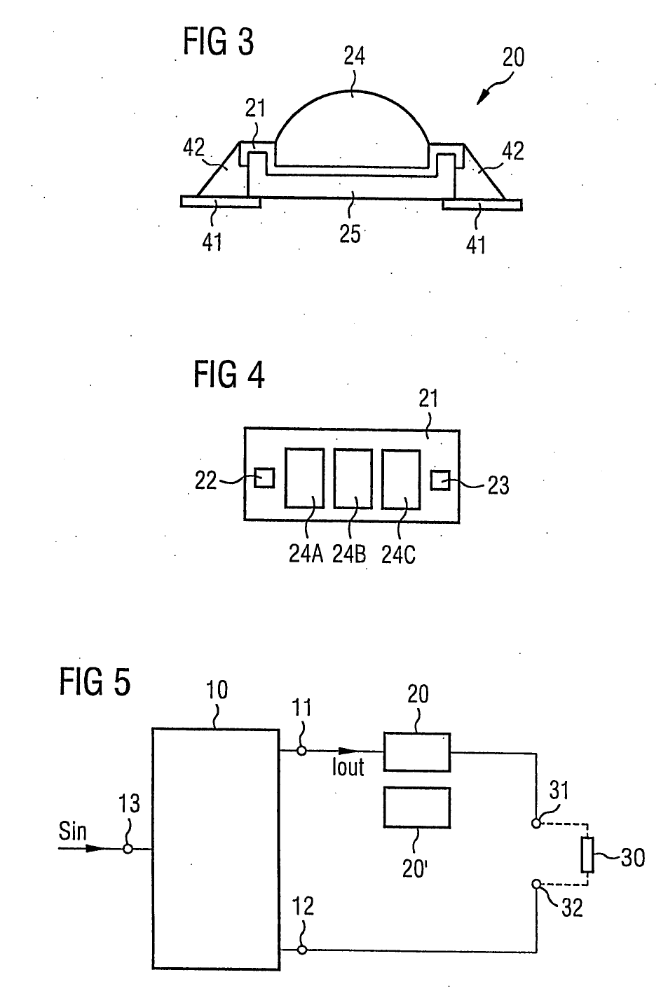

One possibility for the realization of the detector element 20 is illustrated in detail in FIG. 3. In the case of this detector element 20, the electrically conductive carrier 21 is applied to a nonconductive substrate 25, for example made of a ceramic, and is electrically conductively connected by means of soldering connections 42 to a connection line 41 connected between one of the terminals of the current or voltage source (10 in FIG. 1) and one of the ignition element terminals (31, 32 in FIG. 1). The form of the electrically conductive carrier 21 is adapted to the form of the substrate 25, which has a cutout 251 for receiving the thermochromic sensor material 24.

In order to prevent the transition temperature of the thermochromic sensor material 24 from being exceeded during the production of the soldering connections 42, in the production of the detector element 20 illustrated in FIG. 3, firstly the soldering connections 42 between the electrically conductive carrier 21 and the line connection 41 are produced, and only afterward is the thermochromic sensor material 24 introduced into the cutout of the substrate 25, and the corresponding cutout of the electrically conductive carrier 21.

In order to enable a more differentiated statement about the heating of the detector element 20 due to an ignition current Iout flowing from the current or voltage source 10 to the ignition element 30, a plurality of different thermochromic sensor materials 24A-24C having different transition temperatures may be applied to the carrier 21. If the transition temperatures of the individual sensor materials 24A-24C are ordered according to magnitude, then two adjacent transition temperatures in each case form a temperature range. If the sensor material having the lower of said two transition temperatures changes color, while the sensor material having the higher transition temperature remains with its color unchanged, then the information that the temperature has risen into this temperature range, but not beyond it, can be derived from this.

A further differentiation of the temperature conditions after the flowing of an ignition current is made possible, referring to FIG. 5, by a further detector element 20′, which may be constructed in a manner corresponding to the detector element 20 connected into the current path, but which is not connected into the current path and therefore serves only for detecting the ambient temperature. The further detector element 20′ may be thermally insulated from the line connection between the current or voltage source 10 and the ignition element 30 and from the detector element 20 in order largely to avoid heating of the further detector element 20′ due to the ignition current Iout flowing in the current path. It may be advantageous if the detector element 20′ is constructed in a manner corresponding to the detector element illustrated in FIG. 4 and has a plurality of thermochromic sensor materials 24A-24C having different transition temperatures.

The further detector element 20′ is heated exclusively via the ambient temperature. If the evaluation of the color of the further detector element 20′ then reveals that the ambient temperature upon triggering of the ignition element was within a first temperature range and the temperature of the second detector element 20 was within a second temperature range, then this yields the information that the temperature difference between these two temperature ranges is due to the ignition current Iout, which heats the detector element 20 connected into the current path further by comparison with the ambient temperature.

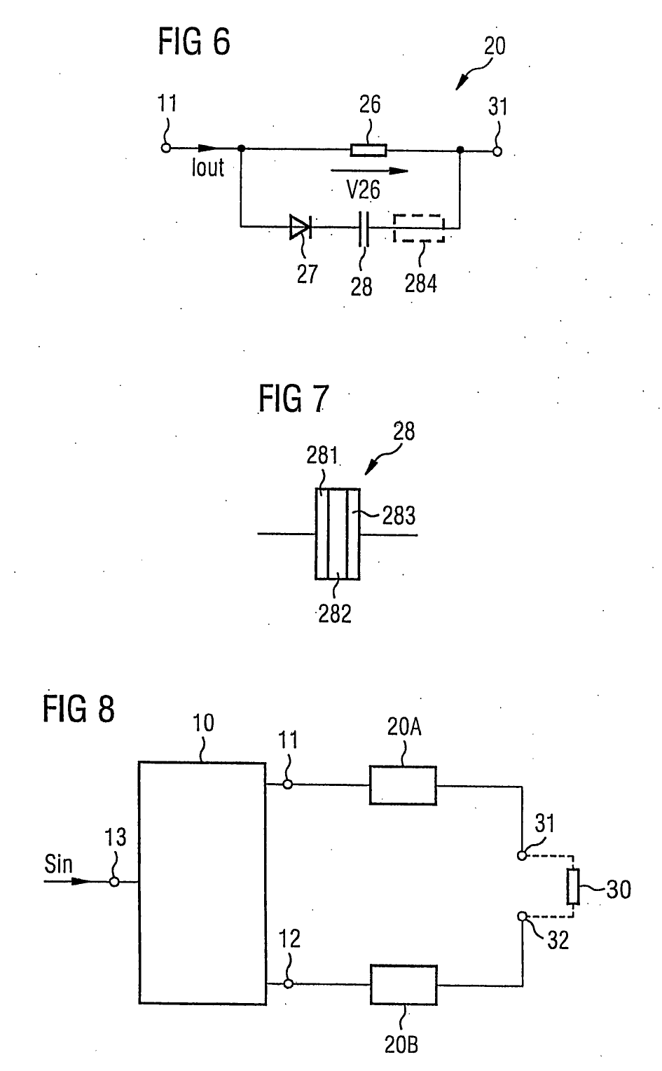

FIG. 6 shows the electrical equivalent circuit diagram of a further detector element 20 that can be used in the drive circuit illustrated in FIG. 1. This detector element 20 comprises an electrochromic cell 28, the electrical properties of which are comparable with a capacitor. Such an electrochromic cell 28 comprises, referring to FIG. 7, first and second electrodes 281, 283, between which an electrochromic sensor material 282 is arranged. An electrochromic sensor material has the property of varying its color depending on an electric field to which it is exposed. In order to be able to identify such a color variation, one of the two electrodes 281, 283 may be formed as a transparent electrode.

The electric field to which the electrochromic sensor material 282 is exposed is caused by an electrical charge stored on the electrodes 281, 283.

In the detector element 20, the electrochromic cell 28 is connected in parallel with a resistance element 26, across which the ignition current Iout brings about a voltage drop V26. A further resistor 284 is optionally connected upstream or downstream of the electrochromic cell, said further resistor having a very large value in comparison with the resistor 26 and having the effect that a current flow through the electrochromic cell 28 is very small in comparison with the ignition current Iout.

In the case of this detector element in accordance with FIG. 6, when an ignition current Iout flows from the current or voltage source 10 to the ignition element 30, electrical charge is stored in the electrochromic cell 28. Said electrical charge is directly dependent on the ignition current Iout and the duration during which said ignition current flows. The color of the electrochromic sensor material 282 of the electrochromic cell 28 yields information about the electric field prevailing between the electrodes 281, 283 or the electrical voltage present between said electrodes, since the electrochromic sensor material changes its color depending on said electric field or said voltage.

The color change procedure is reversible in the case of customary electrochromic sensor materials. In order still to enable a statement about the ignition current Iout that flowed previously even after the ignition current Iout has been turned off, it is necessary to permanently store the electrical charge in the electrochromic cell 28. Assuming low leakage currents, this is achieved by means of a rectifier element, for example a diode 27, which is connected upstream or downstream of the electrochromic cell 28 and which enables the electrochromic cell 28 to be charged but prevents said electrochromic cell from being discharged.

FIG. 8 shows a modification of the drive circuit illustrated in FIG. 1, in which two detector elements 20A, 20B are present, one of which detector elements is connected between the first terminal 11 of the current or voltage source 10 and the first ignition element terminal 31 and the other of which detector elements is connected between the second terminal 12 of the current or voltage source and the second ignition element terminal 32. The two detector elements 20A, 20B may be realized in a manner corresponding to one of the detector elements explained above. The provision of these two detector elements 20A, 20B makes it possible, after triggering of the ignition element 30, to make a statement about whether the current that flowed from the current or voltage source 10 to the ignition element 30 corresponds to the reverse current from the ignition element 30 to the current or voltage source 10. These currents are not identical for example if a shunt were present through which the ignition element 30 is at reference potential (GND in FIG. 11) whilst bypassing the current or voltage source 10. The second switch (15) present for safety purposes in FIG. 11 of the current or voltage source 10 would then be ineffective.

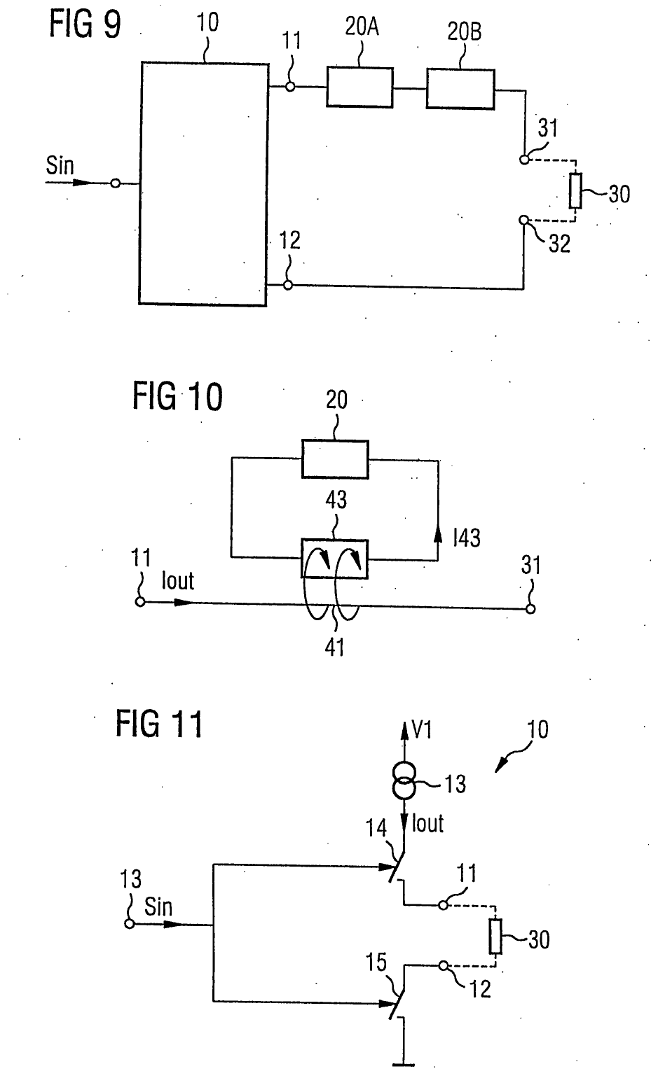

Referring to FIG. 9, there is also the possibility of connecting two detector elements 20A, 20B directly in series into the current path of the ignition element 30. Such a use of two detector elements 20A, 20B connected in series may be expedient for redundancy reasons.

In the exemplary embodiments of the drive circuit according to the invention that have been explained up to now, the at least one detector element 20 present is connected directly into the current path between the current or voltage source 10 and the ignition element 30. With the provision of a thermochromic cell in the detector element, part of the ignition current is in this case branched off for charging the electrochromic cell. With the provision of a detector element having a thermochromic sensor material, the electrical resistance of the current path increases due to the electrically conductive carrier 21 that is heated up.

A possibility for realization in which a direct loading of the current path between the current or voltage source and the ignition element 30 is avoided is illustrated in FIG. 10. In this realization, the detector element 20, which may be realized in a manner corresponding to one of the detector elements explained above, is connected between terminals of a Hall element 43. Said Hall element is inductively coupled to a line connection 41 connected between the current or voltage source and the ignition element 30. The ignition current Iout flowing in said line connection 41 generates a magnetic field that permeates the Hall element 43. In this case, after a defined field strength of said magnetic field has been exceeded, the Hall element 43 generates a constant voltage, which drives a detector current I34 through the detector element 20 and that therefore leads to a change in color of the thermochromic or electrochromic sensor material present in the detector element 20.

What is claimed is:

1. A drive circuit for an ignition element of a safety system, comprising:
at least one ignition element terminal for connection of the ignition element,
a controllable current or voltage source coupled to the at least one ignition element terminal, and
a sensor arrangement comprising at least one detector element which is arranged in a current path or adjacent to a current path between the current or voltage source and the at least one ignition element terminal and which has a sensor material designed to vary its color indirectly or directly dependent on a current flowing between the current or voltage source and the ignition element.

2. The drive circuit as claimed in claim 1, in which the sensor material is an irreversible thermochromic material.

3. The drive circuit as claimed in claim 1, in which the detector element has an electrically conductive carrier and an irreversible thermochromic material applied to the carrier, the carrier being connected between the at least one ignition element terminal and the controllable current or voltage source.

4. The drive circuit as claimed in claim 3, in which the carrier is embodied in plate-type fashion and has two terminal contacts arranged at a distance from one another.

5. The drive circuit as claimed in claim 3, in which at least two different thermochromic materials are applied to the carrier alongside one another.

6. The drive circuit as claimed in claim 5, in which the at least two different thermochromic materials have different transition temperatures.

7. The drive circuit as claimed in claim 1, in which the detector element comprises an electrically conductive thermochromic polymer.

8. The drive circuit as claimed in claim 1, in which at least two detector elements are connected in series between the at least one ignition element terminal and the current or voltage source.

9. The drive circuit as claimed in claim 1, in which the drive circuit has a first and a second ignition element terminal to which the current or voltage source is connected, and in which at least one first detector element is connected between the first ignition element terminal and the current or voltage source, and in which at least one second detector element is connected between the second ignition element terminal and the current or voltage source.

10. The drive circuit as claimed in claim 2, in which the sensor arrangement has a further detector element having a thermochromic material, which is arranged in a manner electrically insulated from the current or voltage source and the ignition element.

11. The drive circuit as claimed in claim 1, in which the sensor material has an electrochromic material.

12. The drive circuit as claimed in claim 11, in which the detector element has:
a resistance element connected between the current or voltage source and the ignition element, and
an electrochromic cell connected in parallel with the resistance element.

13. The drive circuit as claimed in claim 12, in which the electrochromic cell has a first and second electrode and an electrochromic material arranged between the electrodes.

14. The drive circuit as claimed in claim 12, in which a rectifier element is connected upstream or downstream of the electrochromic cell.

15. The drive circuit as claimed in claim 1, in which the detector element is connected to a Hall element inductively coupled to a line connection between the current or voltage source and the ignition element.

16. A system for an ignition element of a safety system, comprising:
at least one detector element composed of a sensor material configured to vary color in accordance with a current flowing therethough;
a first terminal for operably connecting the at least one detector element to the ignition element; and
a second terminal for operably connecting the at least one detector element to a current source for driving the ignition element.

17. The system of claim 16, wherein the sensor material is an irreversible thermochromic material.

18. The system of claim 16, wherein the detector element has an electrically conductive carrier and an irreversible thermochromic material applied to the carrier.

19. A system for an ignition element of a safety system, comprising:
a current path between a current source and an ignition element of a vehicle safety system;
at least one detector element operably connected to the current path, the at least one detector element being composed of a sensor material configured to vary color in accordance with a current flowing in the current path.

20. The system of claim 19, wherein the sensor material is an irreversible thermochromic material.
